(19) United States
(12) Patent Application Publication
(10) Pub. No.: US 2019/0014622 A1
(43) Pub. Date: Jan. 10, 2019

(54) COMPACT HEATER

(71) Applicant: Michael J. Nikols, Holladay, UT (US)

(72) Inventor: Michael J. Nikols, Holladay, UT (US)

(21) Appl. No.: 15/644,452

(22) Filed: Jul. 7, 2017

(51) Int. Cl. H05B 6/10; H05B 6/80

(52) U.S. Cl. CPC H05B 6/108; H05B 6/804

(57) ABSTRACT

The present invention is directed to a fluid heating apparatus comprising a substantially thin and flat spiral-shaped, closed channel. The channel may be enclosed about by a conductive material which heats under inductive, electromagnetic forces. The apparatus is configured to conduct fluid through the channel, the fluid being heated in the channel. The apparatus may also comprises an induction coil disposed adjacent the spiral channel to induce heat in the spiral channel. The spiral channel defines an inlet and an outlet. The apparatus of the present invention is configured to be disposed in spatially small or confined environments and to provide on demand heating of a desired fluid.

### BACKGROUND OF THE INVENTION

### 1. Field of the Invention

The present invention relates to substantially thin and flat spiral-shaped heater cells comprising one or more closed spiral channels in a system in which water or other fluid or media is heated in the channel substantially immediately adjacent to discharge from the system thereby providing heated water, fluid, solution or other media on demand as needed by the user. The heating can be accomplished using electromagnetic or radio frequency induction or microwave heaters and other known heater exchangers. In particular, the present invention relates to apparatuses, systems and methods for fabricating compact heaters used to heat fluids, solids, gases or other media.

### 2. Background and Related Art

Using different types of induction to heat materials and media such as fluids is well known. However, different embodiments have provided different advantages. For example, United States Patent Publication No. US 2011/0165299 A1 published Jul. 7, 2011 discloses wrapping a induction coil in a helical arrangement around an object to be heated and heating the object by electromagnetic induction. Induction heating coils have been used to induce heat in adjacent objects and their contents, see United States Patent Publication No. US 2005/0115957 A1 published Jun. 2, 2005.

Helical tubing configurations have been used in other heating devices. A steam-producing boiler is disclosed in United States Patent Publication No. US 2006/0213457 A1 published Sep. 28, 2006 disclosing wrapping tubes carrying water around a boiler in a spiral/helix arrangement to capture the heat of the boiler. United States Patent Publication No. US 2010/0031899 A1 published Feb. 11, 2010 discloses a water-conducting helical coil suspended inside a water heating tank heated by exterior bands and a heating element inside the tank. These designs do not meet the needs of the present invention.

Thus, while techniques currently exist that are used to create heat and/or heat water, challenges still exist and the best practice has not been utilized including efficiently heating water or other fluids in critically confined spaces. Accordingly, it would be an improvement in the art to provide means for placing tank-less, low profile, energy efficient flow through heaters in confined spaces dictated by the environment of use.

### SUMMARY OF THE INVENTION

The present invention relates to apparatuses for heating water or other media, including air, in critically confined spaces. The present invention is directed to tank-less, low profile, energy efficient flow through heaters which due to their configuration can be effectively placed in confined spaces dictated by the particular environment of use.

Implementation of the present invention takes place in association with the need to heat water or other fluids or media on demand. In particular, the present invention is directed to substantially flat and thin induction heaters capable of being placed in either horizontal or vertical positions. The present invention comprises low profile, closed channels arranged in arrangements such as a spiral configuration. A spiral channel can be formed in a number ways including but not limited to tubing, channels within a body or one or more channels formed in bodies positioned adjacent each other so as to form the desired conduit. The spiral configuration has the advantage of minimizing flow head losses and turbulent flow inherent in other configurations such as serpentine or reverse-flow arrangements.

The low profile nature of the present invention permits more than one heater cell of the present invention, if desired, to be placed in series or parallel, in stacked or adjacent proximity to each other to create boiler cells depending physical constraints of the environment of use thereby facilitating low pressure or gravity flow systems utilizing the present invention.

While the methods and processes of the present invention have proven to be particularly useful in the area of heating various media, those skilled in the art can appreciate that the methods and processes can be used in a variety of configurations for different applications and in a variety of different areas of manufacture to yield efficient means for heating other fluids for on demand use.

These and other features and advantages of the present invention will be set forth or will become more fully apparent in the description that follows and in the appended claims. The features and advantages may be realized and obtained by means of the outlined methods and processing of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIGS. 1A and 1B illustrate a spiral tubing configuration of the present invention;

FIGS. IC and 1D illustrate alternative coil configurations accommodating a plurality of spiral having different diameters;

FIG. 2 illustrates a spiral conduit configuration within a body of the present invention;

FIG. 2A illustrates two alternative configuration of a spiral channel for the configuration of FIG. 2.

FIG. 2B illustrates two components of another embodiment of FIG. 2.

FIG. 3A illustrates a plurality of spiral conduit configurations in a stacked arrangement;

FIG. 3B illustrates a plurality of spiral conduit configurations in another arrangement;

FIG. 4 illustrates a system employing the heater of the present invention; and

FIGS. 5A-5C illustrate exemplary environments of use.

### DETAILED DESCRIPTION OF THE INVENTION

The present invention relates to substantially thin and flat spiral-shaped heater cells comprising one or more closed spiral channels in a system in which water or other fluid or media is heated within the channel substantially immediately adjacent to discharge from the system thereby providing heated water, fluid, solution or other media on demand as needed by the user.

In the disclosure and in the claims of this patent the term “on demand” or “instant” shall mean, but not be limited to, substantially immediately at the desired place of use or so substantially close to the place of use that the heated fluid retains its heated temperature without any material decrease of temperature from the time it is heated until the time the fluid exits the systems and is accessed by the user outside the heating system. In other words, instead of batch heating a tank or reservoir of media and maintaining the temperature of the tank, the media is heated substantially near the point of intended use without the need for a heating a tank of media and maintaining the temperature of the media in the tank.

The present invention utilizes known electromagnetic or radio frequency induction or microwave principles, but does so in a novel channel or cell configuration allowing novel arrangements. In the alternative, conventional heating sources such as electrical or flame may be utilized. As known by those skilled in the art, induction heating can be used electromagnetically or by radio frequency to create heat in conductive materials. The present invention improves upon the use of induction heating in the field of on demand use in physically confined or limited spaces or at locations remote from traditional heater or boiler systems and can be used in an open or closed loop system. The present invention also improves upon the use of microwave heating in the field of on demand use.

From a practical standpoint for safety reasons, any heater should be provided adequate venting. For example, a restaurant work space may comprise a countertop only a few inches thick and/or be located far from the restaurant water heater or boiler yet a sink or other source of hot water is needed at the work space. With only a few inches of host countertop, many conventional on demand systems cannot reside in the available space.

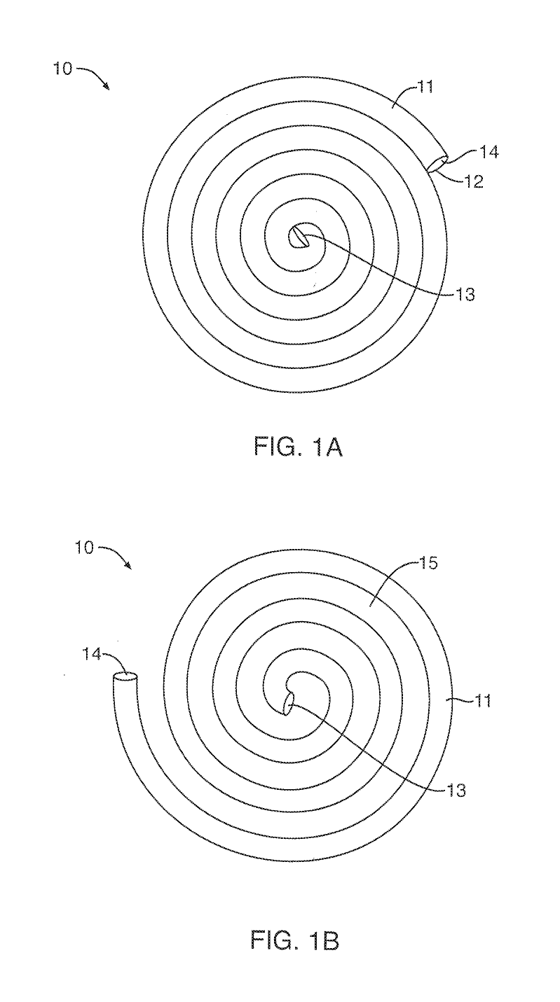

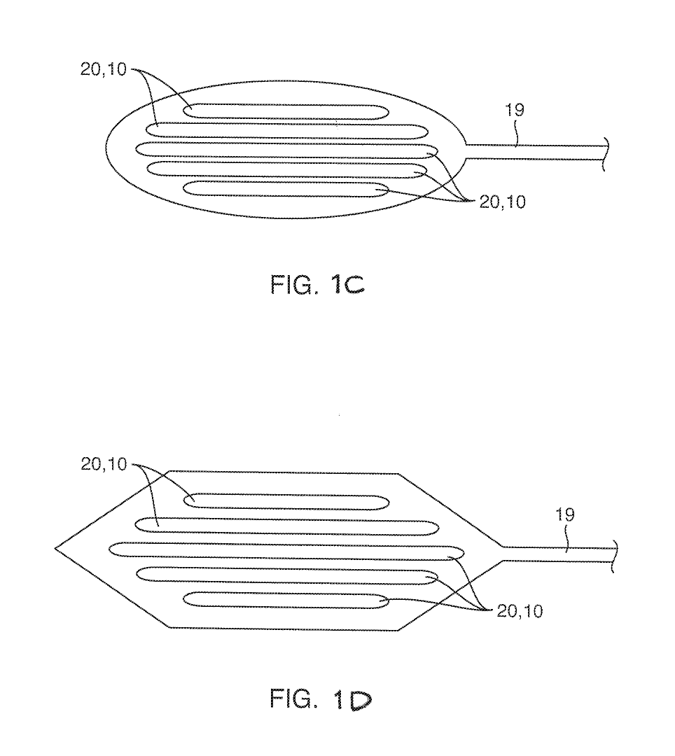

As shown in FIG. 1A, one embodiment of the present invention of spiral apparatus 10 comprises a substantially thin and flat, spiral configuration of a channel formed from channels walls such as tubing 11 through which a media such water, other fluid(s) or gas(es) passes. The elongate wall of tubing 11 defining channel 12 which may have a variety of geometric cross-sectional shapes which may be round, oval, square, rectangular, triangular or any other geometric shape or configuration that does not substantially impede the flow of water or fluid through channel 12.

As shown in FIG. 1A, the adjacent walls of radially spaced portions of tubing 11 contact each other. As shown in FIG. 1B, the adjacent walls of radially spaced portions of tubing 11 may be spaced part with a space 15. The advantage of minimizing space 15 between radially spaced portions of tubing 11 in the spiral configuration is that greater overall channel length can be achieved in the spiral of a chosen diameter. Given the selected heat source used with the coil of FIG. 1B the media passing through channel 12 may experience undesirable heat loss or desired heat gain due to the spacing between adjacent, radially spaced portions of tubing 11.

The channel 12 of tubing 11 comprises a length with openings 13 and 14 along channel 12 of tubing 11. For example, one opening may be at or near the center of the spiral and the other opening may be at or near the periphery of the spiral. Depending on the environment of use and the available physical location of the substantially thin and flat spiral-shaped heating element in relation to the desired location of the output stream from the channel 12 of tubing 11, opening 13 may be either the inlet opening or the outlet opening for coursing media. Similarly, opening 14 may be a corresponding outlet opening or inlet opening, respectively. As needed or desired to provide media at different temperature gradients, additional openings or branches off of the channel 12 of tubing 11 can be disposed along the length of channel 12 between openings 13 and 14. This in one means for controlling a temperature gradient between the inlet of the spiral channel and the outlet of the spiral channel.

The walls defining channel 12 of the present invention may comprise a conductive material which will be heated under the influence of electro-magnetic induction forces. Those skilled in the art will recognize the variability of suitable electromagnetically conductive materials which can be used in the construction of channel 12 in an inductive heating system. For example, channel 12 may be constructed from electrically conductive steel, metal or carbon composite, alloy, chrome, aluminum, copper or any other desirable substance having the desirable heat conductive properties selected by one skilled in the art. Also, electrodeposition, electrogalvanizing or electroplating processes may be used to coat the walls of channel 12, tubing 11 or any surrounding material with compounds which heat when subjected to means for generating heat and which transfers heat to the media within channel 12 or tubing 11. In the alternative the substantially flat spiral channel 12 or tubing 11 may itself not be conductive but may be wrapped or coated with a conductive material. Still further, in the alternative the spiral channel 12 and/or its tubing 11 can be disposed adjacent or against an electrically conductive material subject which is heated under electro-magnetic forces such as a plate or other member on one or both sides of the spiral such that inductive heat is transferred from the plate to the walls defining channel 12 along all or part of the length of channel 12 of the spiral. One of skill in the art can select the conductive material and shape suitable for the desired inductive heating effect. One of skill in the art will also be able to control the temperature differential between openings 13 and 14 by varying the strength of the electro-magnetic induction forces acting on spiral 11 by using conventional mechanisms thereby providing another means for controlling a temperature gradient between the inlet of the spiral channel and the outlet of the spiral channel.

In still another alternative embodiment, the spiral of FIG. 1A may be constructed of material permitting the contents of the spiral to be heated by microwave energy or conventional flame heat source. Those skilled in the art will recognize what construction materials are suitable for microwave heating applications.

The diameter of the spiral tubing configuration is a design or engineering choice left to those of skill in the art for the particular application. For example, depending upon the desired fluid flow rate and temperature differential between inlet and outlet, the length of channel 12 between inlet and outlet is a function of the cross-sectional area of the channel 12 and the overall diameter of the substantially thin and flat spiral configuration. The advantage of the substantially thin and flat spiral configuration is that a variety of flow rates and temperature differentials can be achieved as desired. For example, one half inch wide channel, with width measured radially outward from the center of the channel, in a one foot overall diameter spiral configuration with one half inch spacing between walls of channel 12 would provide approximately eight and one half linear feet of channel 12 through which a flowing media may be heated inside channel 12. On the other hand, with no spacing between walls of channel 12 the linear feet of channel 12 would be approximately seventeen feet. A one quarter inch wide channel in a one foot overall diameter spiral without spacing between the walls of the radially adjacent portions of channels would provide approximately thirty-five lineal feet of channel through which flowing media may be heated inside channel 12. While the illustrated configuration of the spiral is circular, it may be desired to have the spiral be of a different geometric configuration such as an oval or multiple sided such as triangular, square, rectangle, pentagon, hexagon, etc.

In one embodiment, a suitable electric coil or antennae for generating the electro-magnetic forces needed to generate the desired heat in the conductive material about or adjacent channel 12 may be positioned under, over, round-about or sufficiently adjacent to channel 12 so that the spiral configuration lies within the zone of effective electro-magnetic forces produced by the chosen electromagnet coil as discussed later in connection with FIGS. 1C and 1D. As a result, depending upon the required flow rate and temperature gradient a substantially thin and flat spiral-shaped embodiment of the present invention can reside in a horizontal countertop, vertical wall space or other structure as thin as a few inches depending on the configuration of the spiral and it corresponding electromagnet coil.

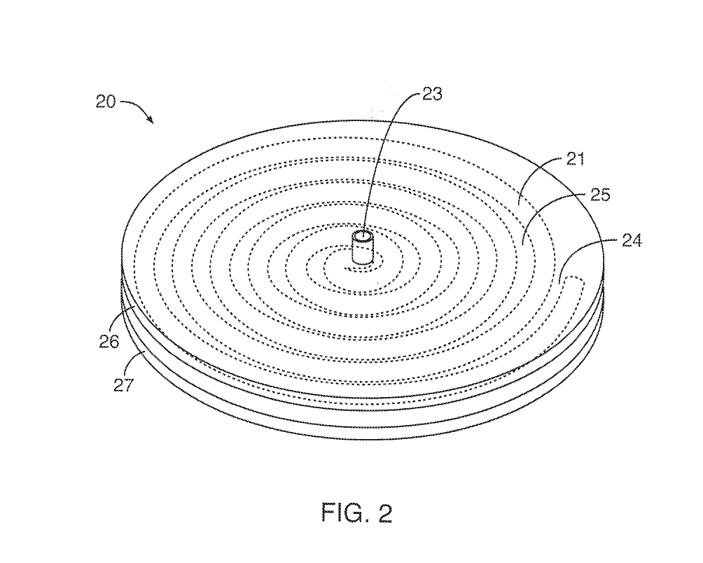

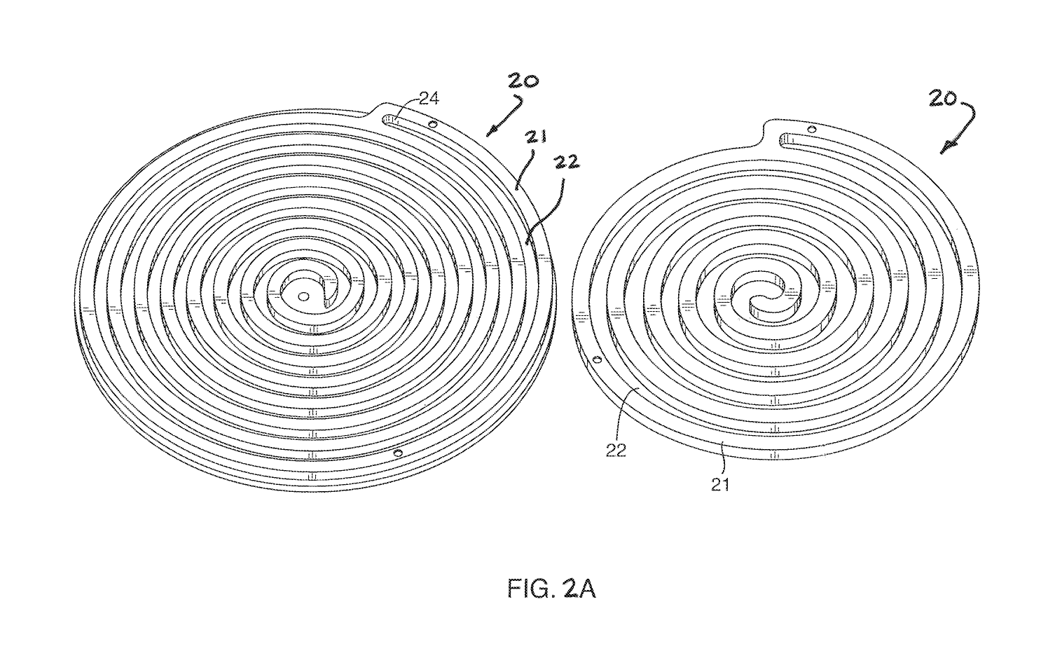

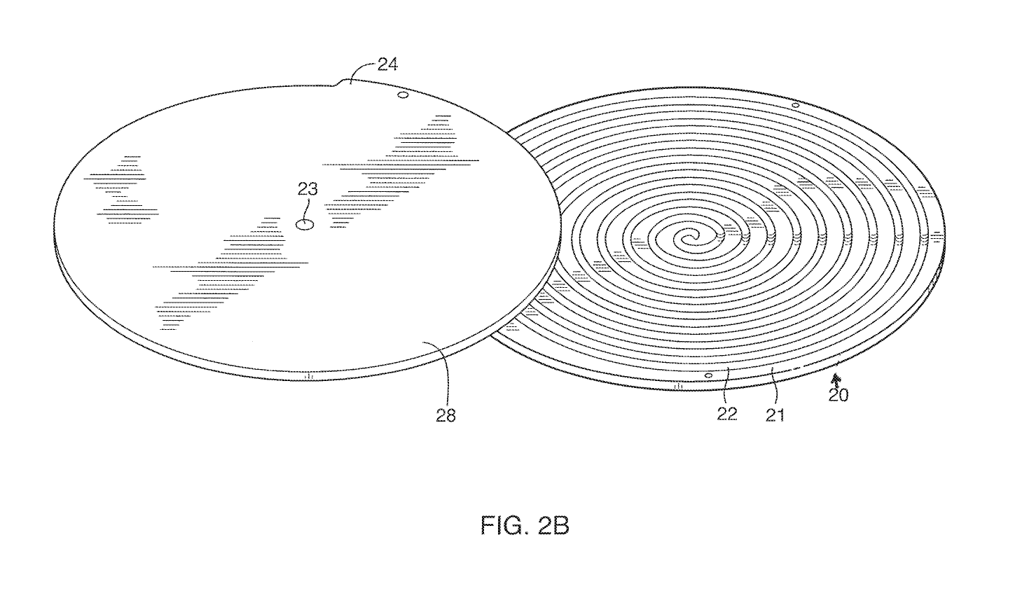

For example, spiral member 21 defining a channel may be disposed between two electrically conductive metal plates 26 and 27 as shown in FIG. 2. Member 21 acts as a conduct in which the media is heated. As shown in FIG. 2, a substantially flat and thin spiral-shaped heating element 20 comprises spiral member 21. Spiral member 21 may comprise an electrically conductive material. Spiral member 21 may be tubing defining a hollow channel therein with a gap or space 25 between radially adjacent portions of member 21. Spiral member 21 is disposed between an upper boundary 26 and a lower boundary 27. Upper boundary 26 and lower boundary 27 may comprise plates which are also subject to heating when a means for heating is applied to boundary 26 and/or boundary 27. Locations 23 and 24 of FIG. 2 illustrate possible inlet and outlet openings.

In an alternative configuration shown in FIG. 2A, spiral configurations 20 comprises a solid spiral member 21. Solid spiral 21 is configured to define an open channel 22 between each radially adjacent solid spiral portion. The solid spiral 21 is depicted in FIG. 2A in which the solid spiral comprises conductive metal with an inlet location 24. Water or other media passes through channel 22 when solid spiral 21 is closed or bounded on each side with a plate or other surface such as plates 26 and 27 of FIG. 2 which isolate each concentric section of channel 22, or which design allows communication between concentric section of channel 22 as needed or desired. For example, solid spiral 21 may be likewise disposed between an upper boundary 26 and a lower boundary 27 whereby spiral channel 22 is bounded or closed to contain water/media coursing through channel 22. An outlet can be configured in either boundary 26 or 27 as desired. The solid spiral 21 of FIG. 2A can be constructed by casting, stamping or cutting such as laser cutting.

In another alternative configuration 20, the channel through which water/media passes is defined by a groove or recess 22 formed in a solid host member 21 as shown in FIG. 2B. In this embodiment material is removed from solid host member 21 to form all or part of a channel 22 with an inlet 24 near the periphery of member 28. Solid host member 21 is thus configured to define at least a portion of channel 22. Solid host member 21 depicted in FIG. 2B comprises conductive metal. Media passes through the channel 22. Solid host member 21 is disposed adjacent member 28. Member 28 is placed in sealing relation to solid member 21 to close channel 22. An outlet 23 can be configured in member 28, or alternatively in host member 21.

In the alternative, member 28 can comprise a solid member and be configured with a matching channel 22′ (not shown) defined by a groove or recess on the side of member 28 adjacent channel 22 by removing material from solid member 28 to form all or part of a channel 22′. Solid member 28 is thus configured to define a mirror open channel 22′. The solid member 28 depicted in FIG. 2B comprises conductive metal. Solid member 21 and solid member 28 are positioned adjacent each other in sealing relation such that channel 22 and mirror channel 22′ form a closed channel 22-22′. Media passes through closed channel 22-22′ for heating.

In a further alternative embodiment solid host members 21 and 28 of FIG. 2B could be prepared by using stamping procedures in which channel 22 and/or 22′ are formed in solid members 21 and 28. For example, using stamping manufacturing processes channel 22 and 22′ are created in one or both of solid members 21 and 28 in a clam shell-type arrangement and then joined together by suitable means to configure channel 22-22′ as desired. In another alternative embodiment, a selected tubing could be disposed within channel 22 or 22-22′ if desired. Still further, channel 22 and or 22′ could be lined, coated or plated with any desirable material such as steel, chrome, carbon, aluminum, copper or any other desirable substance having the desirable heat conductive properties selected by one skilled in the art.

In the various embodiments of FIGS. 1, 1B, 1C, 1D, 2, 2A and 2B the defined channel 12, 22 and 22-22′ comprises a closed length with openings 13 and 14, and 23 and 24, preferably but not necessary at the extreme ends of the channel. Depending on the environment of use and the available physical location of the substantially thin and flat spiral-shaped heating element in relation to the desired location of the output stream from channel 12, 22 or 22-22′, openings 13 or 23 may be either the inlet opening or the outlet opening. Similarly, openings 14 or 24 may be a corresponding outlet opening or inlet opening, respectively.

In all embodiments of FIGS. 2, 2A and 2B the material surrounding, lining or coating channel 22 and channel 22-22′ comprises a conductive material which may be heated when subjected to means for generating heating such as under the influence of electro-magnetic induction forces to transfer heat to channel 22 and 22-22′ and to any media flowing through the closed channel. As shown in FIG. 2, upper boundary 26 and lower boundary 27 may also be constructed of a conductive material which will be heated by induction forces. Those skilled in the art will recognize the variability of suitable conductive materials which can be used in the construction of spiral 21, host member 21, boundaries 26 and 27 and member 28 in a conductive heating system. For example, they may be any suitable material for inductive heating. One of skill in the art can select the conductive material suitable for the desired heating effect. In the alternative, host member 21, boundaries 26 and 27 and member 28 may comprise a high heat plastic or ceramic material when the subject media is heated by microwave energy. In the alternative members 21, 26, 27 and/or 28 may comprise any suitable composition which will endure heating by conventional flame or electrical heating sources.

As shown in FIGS. 2 and 2A, spiral 21 and boundaries 26 and 27 can be three separate pieces joined together about channel 22 or 22-22′ by soldering, welding, gasket or the like so as encircle channel 22 with conductive material Similarly a clam shell-like configuration produced by stamping may be similarly joined together or by use any suitable epoxy, glue, welding or gasket corresponding to the selected, stamped, clam shell-like members 21 and/or 28.

As illustrated with the embodiment of FIG. 1, the diameter of the substantially thin and flat spiral-shaped heating element 20 of the embodiments of FIGS. 2A and 2B is also a design choice left to those of skill in the art. For example, depending upon the desired fluid flow rate and temperature differential between inlet and outlet, the length of the closed channel between an inlet and an outlet is a function of the overall diameter of the heating element 20, the cross-section of the closed channel and spacing, if any, between adjacent segments of the closed channel. With the spiral configuration a variety of flow rates and temperature differentials can be achieved as desired. For example, if conductive host material comprising spiral 21 of FIG. 2A has a width measured of one half inch then in a one foot diameter spiral with one half inch channel 12 between adjacent segments of host material 21 then heating element 20 provides approximately eight and one half linear feet of conduit channel through which a flowing fluid may be heated inside channel 22.

For the present invention, in order to induce heating of the selected conductive material about the enclosed channel 12, 22 or 22-22′, heating element 10 or 20 may be disposed near or within a suitable induction coil or antennae chosen to generate the electro-magnetic forces needed to generate heat in the conductive material. That is, a suitable induction coil for generating the electro-magnetic forces needed to generate the desired heat in the conductive material about the enclosed channel is positioned under, over, round-about or sufficiently adjacent to heating element 10 or 20 so that the components of heating element 10 or 20 lie within the zone of effective electro-magnetic forces produced by the chosen induction coil or antennae.

For example, tubing 11 may be wrapped about and along the length of tubing 11 (not shown) or channel 12 such that channel is encircled about with a suitable induction coil or antennae 19 chosen to generate the electro-magnetic or radio frequency forces needed to generate heat in the conductive material comprising tubing 11. Another example would be the use of elliptical or hexagonal coils which permit more than one spiral cells to be disposed within the coil and allows element 10/20 having different diameters to be positioned in a stacked configuration near each other in a pancake stack fashion while keeping the peripheries of the spirals the appropriate distance from the induction coil 19 as shown in FIGS. 1C and 1D. In this way, a number of heating elements 10 or 20 can be heated using the same induction coil 19. For example, the suitable coil 19 may be chosen from many geometric shapes such as circular, rounded, oval, elliptical or other multi-sided configuration, or in helical, cylindrical or other round-about or encompassing configuration identified by one of skill in the art as suitable.

As a result, depending upon the required flow rate and temperature gradient of the media coursing through channel 12, 22 or 22-22′ a substantially flat and thin spiral-shaped embodiment 10 or 20 of the present invention can reside in a horizontal countertop, vertical wall space or other structure wherein the diameter of the channel of the spiral is as small as ⅛ inch up to 4 inches, preferably about ¼ to ½ inch in dimension. Or, as needed and as determined by one of skill in the art, the diameter of the channel of the spiral could be much larger if adapted for commercial or industrial use applications.

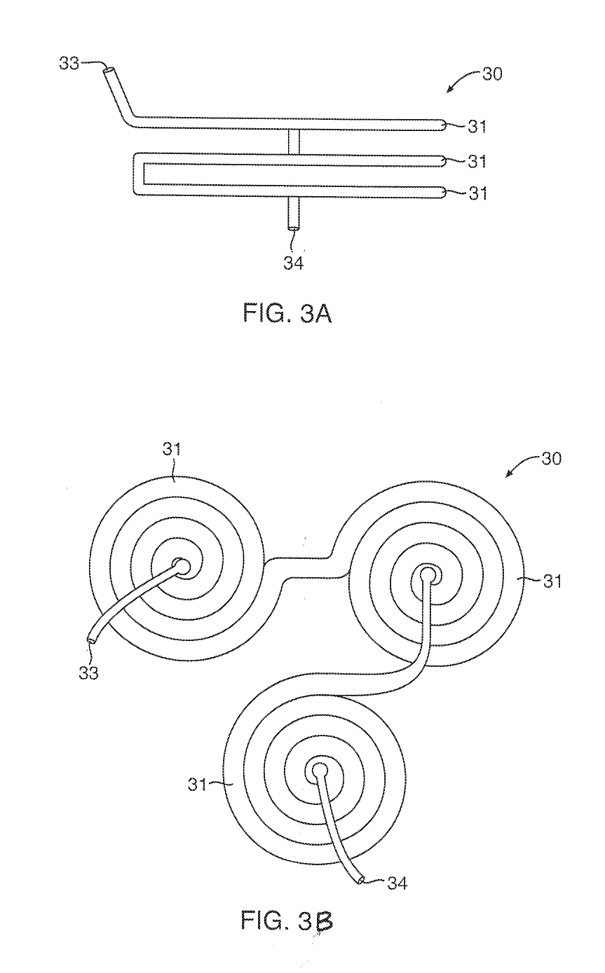

As illustrated in FIG. 3A, a heating element 30 comprises a plurality of substantially thin and flat spirals 31 each having an enclosed channel, as shown in a side view, which can be disposed in a vertical, stacked, series configuration depending on the availability of physical space for the placement and use of heating elements. In this stacked configuration more than one spiral 31 are interconnected with inlet 33 and outlet 34. Spiral 31 could comprise either tubing 11 or spiral 21 configurations, or a mixture of both. In this stacked configuration, one or more heating spirals constructed of conductive material may be heated using the same induction coil 19. This can increase the efficiency and productivity of the heating configuration.

As illustrated in FIG. 3B, an alternative embodiment of heating system 30 comprises a plurality of heating spirals 31, as shown in plan view, each spiral 31 being disposed in a substantially, co-planar, series configuration depending on the availability of physical space for the placement and use of heating system 30. Element 30 comprises inlet 33 and outlet 34. In this more co-planar configuration more than one spiral can comprise either tubing 11 or spiral 21 configurations, or a mixture of both. In this more co-planar configuration, one or more spirals 31 may be heated using the same induction coil 19. This can increase the efficiency and productivity of the heating configuration.

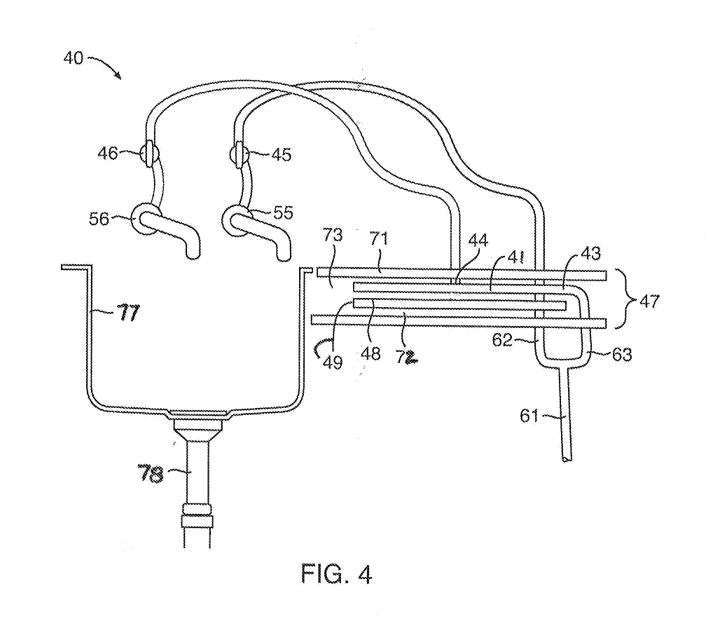

FIG. 4 illustrates a representative work station 40 in which the present invention is operable. Structure 71 illustrates a work station surface such as a countertop. Structure 72 illustrates a lower cabinetry member defining limited environment of use or space 73 between structures 71 and 72. System 40 comprises a water or fluid source 61.

Fluid source 61 could be water or any other desired media such as media at ambient temperature or be the cold water/fluid source. Source 61 is split into source line 62 and input line 63. Input 63 is joined to the inlet 43 of spiral 41 comprising tubing 12 or spiral 21 of heating elements 10 and 20, respectively. A conduit line is joined to outlet 44 of spiral 41 to conduct hot water/fluid to the desired point of use such as a hot faucet 46 of a work station 40. Representative cold water spout 55 with valve 45, hot water spout 56 with valve 46, sink 77 and drain 78 are also illustrated.

As shown in FIG. 4, a suitable induction coil 48 is disposed adjacent spiral 41 in space 47 between elements 71 and 72 so as to induce heating of spiral 41 through which the subject water or fluid may flow. Induction coil 48 is provided power from electrical lead 49. As illustrated, the environment of use 73 has confined physical dimensions. In this way, the heating and plumbing requirements necessitate only one fluid source line and no natural gas line or associated venting (as used with many other on demand heaters) at work station 40. Available electricity already nearby electrical lead 49 can be easily connected to induction coil 48 using convention connections, inverters and/or suitable printed circuitry known to those skilled in the art.

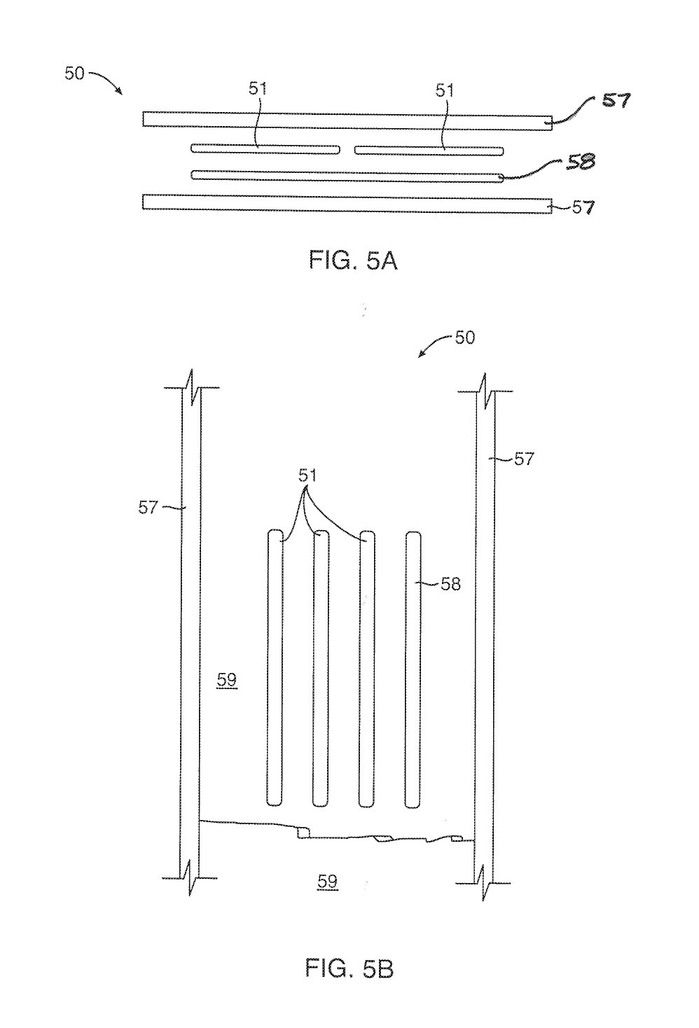

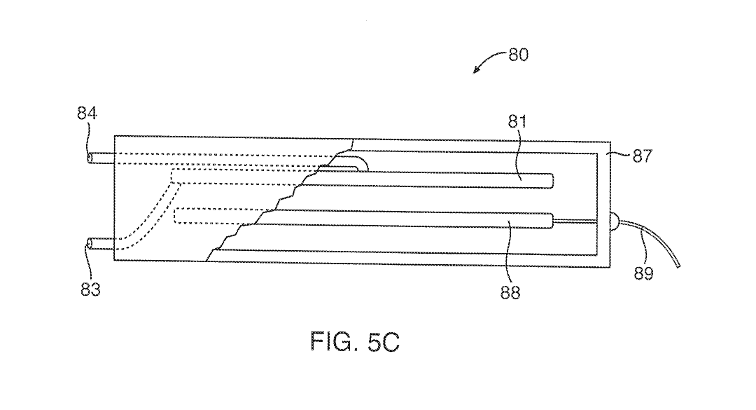

FIG. 5A depicts in side view an environment of use 50 in which a plurality of substantially horizontal spirals 51 (viewed on edge) are disposed above an induction coil 58 between environment walls 57.

FIG. 5B depicts in side view an environment of use 50 in which one or more vertically oriented spirals 51 (seen on edge) are disposed in a stacked configuration adjacent induction coil 58 in space 59 between environment walls 57 shown in a broken away view.

FIG. 5C depicts a contemplated portable heating system 80 employing a portable or moveable housing 87 in which an induction coil 88 is disposed so as to induce heat in spiral 81 having a fluid inlet 83 and outlet 84. System 80 includes a power cord 89 with conventional connection for insertion into an available electrical outlet. A source of water/fluid would be joined to inlet 83 and heated water/fluid would be available at outlet 84 for use as desired. In this way heating system 80 can be positioned vertically or horizontally or at some other angle as the physical space and environment of use permits.

As used herein the term “means for generating heating” comprises the combination of electrically conductive materials with a induction coil for generating electromagnetic forces which induce heat in the electrically conductive materials; the combination of electrically conductive materials with an induction antennae generating radio frequencies which induce heat in the host materials; the combination of ceramic host materials defining a channel heated with microwave energy for heating media conducted in the channel; configurations of channels which can be heated with conventional flame or electrical heating sources; and equivalents thereof.

While the descriptions above highlight the advantages of heat generated by electrically induced principles, heating of spiral shaped conduits described above may be achieved using flame, infrared or other conventional heating methods although likely with a decrease in efficiency. The ready and apparent advantages of inductive heating over other heating mechanisms is the savings of plumbing for fuel and no flue or exhaust conduit for gases of combustion is required. Those skilled in the art may apply inductive, flame, infrared or other conventional heating mechanism with known conventional sensors and related hardware, software, dials switches, valves, etc. thereby allowing the user of the system to have additional means for controlling the temperature gradient between the inlet of the spiral conduit and the outlet of the spiral conduit.

Thus, as discussed herein, the embodiments of the present invention embrace FIGS. 1-5 and equivalents thereof.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A fluid heating apparatus comprising:
a substantially thin and flat spiral-shaped closed channel enclosed about by a host material and configured to conduct a media through the channel;
means for generating heat in the host material such that the heat is transferred to the media conducted through the channel;
an inlet to the spiral channel for receiving the media into the channel; and
an outlet to the spiral channel for discharging media from the channel.

2. The apparatus of claim 1 wherein the means for generating heat comprises enclosing the channel about by conductive material which heats under inductive, electromagnetic forces.

3. The apparatus of claim 1 wherein the means for generating heat comprises enclosing the channel about by host material which heats under radio frequency forces.

4. The apparatus of claim 1 wherein the means for generating heat comprises enclosing the channel about by ceramic material such that the application of microwave energy to the apparatus heats the media in the channel.

5. The apparatus of claim 1 further comprising means for controlling a temperature gradient between the inlet of the spiral channel and the outlet of the spiral channel.

6. The apparatus of claim 1 comprising more than one closed spiral channel adjacent each other.

7. The apparatus of claim 6 where the more than one spiral channels are disposed adjacent each other such that the separate spiral channels lie in substantially the same plane.

8. The apparatus of claim 6 where the more than one spiral channels are disposed adjacent each other such that the separate spiral channels lie in a stacked configuration.

9. A fluid heating apparatus comprising:
a substantially thin and flat spiral-shaped coil of tubing configured to conduct a media through the channel, the tubing comprising an elongate wall member;
means for generating heat in the elongate wall such that the heat is transferred to the media conducted through the tubing;
an inlet to the spiral coil of tubing for receiving the media into the channel; and
an outlet to the spiral coil of tubing for discharging media from the channel.

10. The apparatus of claim 9 wherein the means for generating heat comprises a configuration wherein the coil comprises a heat conductive material which heats under inductive, electromagnetic forces.

11. The apparatus of claim 9 wherein the means for generating heat comprises a configuration wherein the coil comprises a material which heats under radio frequency forces.

12. The apparatus of claim 9 wherein the means for generating heat comprises a configuration wherein the coil comprises a ceramic material which heats under application of microwave energy.

13. The apparatus of claim 9 further comprising means for controlling a temperature gradient between the inlet of the spiral channel and the outlet of the spiral channel.

14. The apparatus of claim 9 comprising more than one spiral of tubing adjacent each other.

15. The apparatus of claim 14 where the more than one spiral channels are disposed adjacent each other such that the separate spiral channels lie in substantially the same plane.

16. The apparatus of claim 14 where the more than one spiral channels are disposed adjacent each other such that the separate spiral channels lie in a stacked configuration.
